(19) United States
(12) Patent Application Publication
(10) Pub. No.: US 2024/0243326 A1
(43) Pub. Date: Jul. 18, 2024

(54) Reversible System Comprising A Reversible Fuel Cell And A Metal Hydride Storage Device

(71) Applicant: Electricite de France, Paris (FR)

(72) Inventor: Aline Leon, Linkenheim (DE)

(73) Assignee: Electricite de France, Paris (FR)

(21) Appl. No.: 18/526,521

(22) Filed: Dec. 1, 2023

(30) Foreign Application Priority Data
Dec. 1, 2022 (FR) 2212633

(51) Int. Cl. H01M 8/18; H01M 8/04029; H01M 8/04089; H01M 8/04298

(52) U.S. Cl. CPC H01M 8/182; H01M 8/04029; H01M 8/04097; H01M 8/04298

(57) ABSTRACT

The invention relates to a system comprising: a fuel cell able to operate in a first and a second operating mode, such that: in the first mode, the fuel cell consumes energy in order to produce hydrogen, and in the second mode, the fuel cell produces energy by consuming hydrogen; a first storage device for storing hydrogen produced by the fuel cell when the fuel cell is in the first mode, the first storage device being able to absorb hydrogen at a first pressure and to release hydrogen at a second pressure, greater than the first pressure; and, a second storage device able to store hydrogen coming from the first storage device, the second storage device being able to absorb hydrogen by forming, with the hydrogen, a second metal hydride when the hydrogen is at the second pressure.

### TECHNICAL FIELD

The invention relates to systems for autonomous storage and production of electrical energy and, more precisely, to reversible systems offering the possibility of generating hydrogen, electricity, heat and/or water. These systems operate autonomously and use a reversible fuel cell.

### PRIOR ART

The development of renewable sources of energy is accompanied by the development of technologies optimising their use and their yields. Among the various available sources of renewable energy, the hydrogen fuel cell, capable of generating electricity while limiting the emission of greenhouse gases, arouses great interest.

The fuel cell is an electrochemical device, the operation of which relies on redox chemical reactions in order to produce electrical energy: oxidation of a reducing fuel at one electrode and reduction of an oxidant at another electrode. The hydrogen fuel cell can, in particular, operate selectively in two operating modes: a first operating mode in which the fuel cell is in the electrolysis regime and a second operating mode in which the fuel cell is in the discharge regime. The solid oxide fuel cell (SOFC) can operate following various chemical reactions involving, for example, methanol, methane or simply molecular hydrogen on the hydrogen-electrode side, and oxygen on the oxygen-electrode side. For simplicity, reference will be made to the case of fuel cells involving oxygen and hydrogen.

In the first operating mode, the electrolysis regime, a first endothermic reaction enables the production of hydrogen and oxygen, by providing energy in the form of electricity and heat:

$${H}_{2} O + Q + 2 {e}^{-} \to {H}_{2} + 1 / 2 {O}_{2} ( electrolysis ) .$$

In the second operating mode, the discharge regime, a second exothermic reaction enables the production of heat and electricity by recombination of hydrogen and oxygen:

$${H}_{2} + 1 / 2 {O}_{2} \to {H}_{2} O + 2 {e}^{-} + Q ( discharge ) .$$

The heat Q and electrical energy e required for the endothermic reaction of electrolysis in order to produce hydrogen at a given temperature and pressure, depend, in part, on the electrical supply used. More specifically, the electrical voltage of the fuel cell in the electrolysis regime enables three different operating modes to be defined: allothermal, exothermal or autothermal.

The autothermal mode corresponds to a mode in which the supply of electrical energy alone enables supply of all the energy necessary for the endothermic reaction, in other words the quantity of heat Q consumed by the endothermic reaction is entirely compensated by the provision of electrical energy which is transformed into heat. The voltage applied to a fuel cell charged in autothermal mode is called a thermoneutral voltage.

The exothermal mode corresponds to a voltage of the fuel cell greater than the thermoneutral voltage. For such voltage values, the provision of energy in electrical form is such that it produces, by itself, more heat than is necessary for the endothermic reaction. This mode consumes more electrical energy and induces temperature variations within the fuel cell which can affect its structural integrity.

The allothermal mode corresponds to a voltage of the fuel cell less than the thermoneutral voltage This mode implies a lower consumption of electrical energy. It is therefore preferable, a priori. However, it supposes an external provision of heat into the fuel cell.

Hydrogen and oxygen fuel cells have the advantage of not emitting greenhouse gases, such as CO₂. One of the disadvantages of their operation resides in the fact that the electrolysis and discharge reactions have very different thermodynamic behaviour: one consumes electrical energy and heat and produces a discharge of gas, the other produces electrical energy and heat and requires a provision of gaseous reactants. Consequently, in order to manage the flows of reagents, products, electrical energy and heat, a storage device enabling storage of hydrogen produced during the endothermic reaction is generally coupled to the fuel cell. The storage device is used to store the hydrogen produced by the fuel cell when the fuel cell operates in the electrolysis regime and restores the stored hydrogen, as a reactant, in order to supply the fuel cell when the fuel cell operates in the discharge regime.

Several technical solutions for storing and then restoring hydrogen are possible. Document WO2013/190024 proposes, for example, a device enabling the reversible storage by absorption of hydrogen in a material.

In addition, document WO2016/146956 proposes using the heat produced during the storage of hydrogen in the material in order to take a fluid, serving to supply the fuel cell with reactants, to a predetermined temperature.

However, the various materials capable of storing hydrogen must be subjected to specific pressure and temperature conditions in order to cause absorption of hydrogen by the material or desorption of hydrogen from the material.

Certain metal materials, such as magnesium for example, can store a large quantity of hydrogen in the form of a metal hydride. However, the absorption of hydrogen by the material requires that the hydrogen is kept at a pressure greater than atmospheric pressure, for example a pressure of 10 bar for magnesium. However, the fuel cell produces hydrogen at atmospheric pressure.

It would be possible to provide a hydrogen compressor enabling the pressure of the hydrogen produced by the fuel cell to be increased in order to supply the storage device with pressurised hydrogen. However, this solution is particularly complex to implement, and is consequently not economic.

### DISCLOSURE OF THE INVENTION

An object of the invention is to provide a solution enabling efficient storage of hydrogen produced by a fuel cell.

This object is achieved in the context of the present invention through a system comprising:
a fuel cell able to operate selectively in a first operating mode and in a second operating mode, such that:
   in the first operating mode, the fuel cell consumes electrical energy in order to produce hydrogen and oxygen, and
   in the second operating mode, the fuel cell produces electrical energy while consuming hydrogen and oxygen;
a first storage device for storing hydrogen produced by the fuel cell when the fuel cell is in the first operating mode, the first storage device comprising a first material able to absorb hydrogen by forming, with the hydrogen, a first metal hydride when the hydrogen is at a first pressure, and releasing hydrogen by desorption when the hydrogen is at a second pressure, greater than the first pressure, the first metal hydride having a first enthalpy of absorption;
a second storage device able to store hydrogen coming from the first storage device, the second storage device comprising a second material, different from the first material, the second material being able to absorb hydrogen by forming, with the hydrogen, a second metal hydride when the hydrogen is at the second pressure, the second metal hydride having a second enthalpy of absorption, greater, in absolute value, than the first enthalpy of absorption of the first metal hydride.

The first storage device thus forms a temporary storage device enabling hydrogen to be taken from the first pressure to the second pressure, in order to supply the second storage device.

The second material can be chosen such that the second storage device is capable of storing a large quantity of hydrogen. Moreover, the heat produced by the absorption of hydrogen by the second material can be used to heat the water which supplies the fuel cell when the fuel cell operates in the first operating mode, which enables the yield of the electrolysis reaction to be increased.

The invention is advantageously supplemented by the following features, taken individually or in any of the possible technical combinations thereof:
the system comprising a first heating device for heating the first metal hydride, so as to take a pressure of hydrogen stored in the first storage device from the first pressure to the second pressure;
the first heating device is able to be supplied with heat by the residual water, which has not been consumed by the fuel cell when the fuel cell operates in the first operating mode;
the second material is able to produce, during the storage by absorption of hydrogen in the second material, a quantity of heat necessary to vaporise the water supplying the fuel cell when the fuel cell operates in the first operating mode;
the system comprising a first heat exchanger able to transfer the heat produced during the storage by absorption of hydrogen in the second material, to the water supplying the fuel cell when the fuel cell operates in the first operating mode;
the first heat exchanger is able to transfer the heat from the water produced by the fuel cell to the second metal hydride, so as to cause a desorption of hydrogen stored in the second storage device, in order to supply the fuel cell with hydrogen when the fuel cell operates in the second operating mode;
the system comprising a second heat exchanger able to transfer heat from the hydrogen produced by the fuel cell to the water supplying the fuel cell, in order to supply the fuel cell with steam when the fuel cell operates in the first operating mode;
the second heat exchanger is able to transfer heat from the water produced by the fuel cell to the hydrogen coming from the first storage device and/or the second storage device, in order to supply the fuel cell with heated hydrogen when the fuel cell operates in the second operating mode;
the system comprising a condenser for separating hydrogen produced by the fuel cell and the residual water which has not been consumed by the fuel cell when the fuel cell operates in the first operating mode;
the first storage device comprises a plurality of storage cells and an inlet/outlet line, each storage cell being able to be supplied with hydrogen coming from the fuel cell and to be discharged of hydrogen to the second storage device via the inlet/outlet line, and a valve able to be controlled in order to selectively connect the inlet/outlet line of each storage cell to a line for transporting hydrogen, configured to transport hydrogen between the fuel cell and/or the first storage device and/or the second storage device, independently of the other storage cells;
the system comprising a connection valve able to selectively connect the second storage device to the first storage device, in order to supply the second storage device with hydrogen coming from the first storage device when the fuel cell operates in the first operating mode, or to the fuel cell in order to supply the fuel cell with hydrogen coming from the second storage device when the fuel cell operates in the second operating mode;
the system comprising a second heating device and a regulator able to control the second heating device in order to keep the fuel cell at a predefined nominal operating temperature between 650° and 850°;
the first material of the first storage device comprises a compound chosen from lanthanum, titanium, vanadium, nickel or a combination of these elements;
the second material of the second storage device comprises magnesium.

Another aspect proposes an operating method of a system as defined above, in which the fuel cell operates in the first operating mode, the method comprising the steps of:
storing, by absorption, hydrogen produced by the fuel cell at the first pressure in the first storage device,
heating the first metal hydride so as to take hydrogen stored in the first storage device from the first pressure to the second pressure,
releasing, by desorption, hydrogen stored in the first storage device, and
storing, by absorption, released hydrogen coming from the first storage device in the second storage device at the second pressure, the second storage device storing the released hydrogen at the same speed as the first storage device releases the stored hydrogen.

Another aspect also proposes an operating method of a system as defined above, wherein the fuel cell operates in the second operating mode, the method comprising the steps of:
heating the second metal hydride so as to cause a desorption of hydrogen stored in the second storage device, and
supplying the fuel cell with desorbed hydrogen coming from the second storage device.

The method can further comprise the steps of:
heating the first metal hydride so as to cause a desorption of hydrogen stored in the first storage device, and
supplying the fuel cell with desorbed hydrogen coming from the first storage device.

### DESCRIPTION OF THE FIGURES

Other features, aims and advantages of the invention will emerge from the following description, which is given purely by way of illustration and not being limiting and which should be read with reference to the attached drawings, in which:

FIG. 1 schematically represents a system according to a possible embodiment of the invention;

FIG. 2 schematically represents the system operating according to a first operating mode;

FIG. 3 schematically represents the system operating according to a second operating mode;

FIGS. 4A and 4B respectively illustrate steps of a first operating method of the system and a second operating method of the system.

In all the figures, similar elements have identical reference signs.

### DETAILED DESCRIPTION

### General System

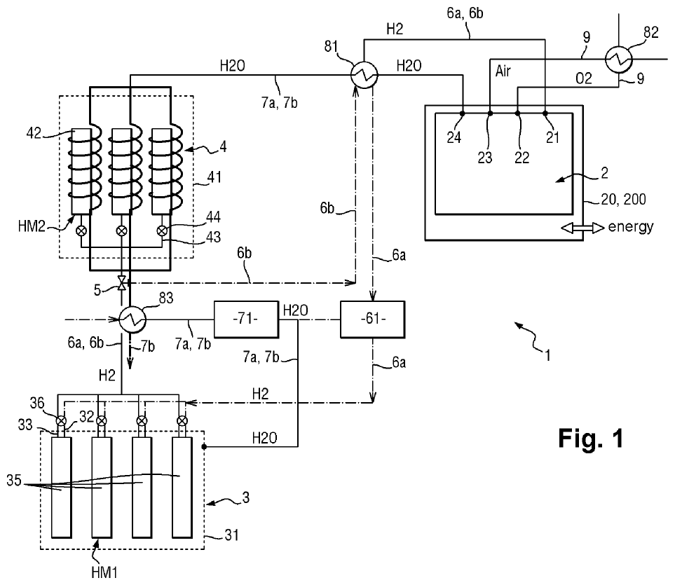

In FIG. 1, the system 1 comprises a fuel cell 2, a first storage device 3 (or low-pressure storage device) and a second storage device 4 (or high-pressure storage device).

The fuel cell 2 generally comprises a plurality of elementary cells (non shown) each comprising an anode and a cathode. FIG. 1 shows, by way of example, a fuel cell 2 capable of producing molecular hydrogen H₂. For simplicity, this will be referred to subsequently as hydrogen H₂. The invention can however be implemented on other categories of fuel cells using, as a hydrogen H₂ based compound, compounds other than molecular hydrogen H₂, such as methanol or methane, for example.

The term “reversible fuel cell” shall mean a fuel cell designed to selectively consume a chemical reactant A and a chemical reactant B, in order to produce electrical energy and a chemical compound C, or to consume electrical energy and the chemical product (thus becoming the reactant) C, in order to produce compounds A and B. The term “reversible hydrogen cell” therefore means a fuel cell which is able selectively to produce:
hydrogen H₂ according to a first reaction R1, by decomposition of a fluid comprising hydrogen atoms H, and
electrical energy and heat according to a second exothermal reaction R2, by recombination of oxygen O₂ and hydrogen H₂.

The first reaction R1 is advantageously carried out when the fuel cell 2 operates in the electrolysis regime. The first reaction R1 is implemented in the fuel cell 2 when this operates according to a first operating mode F1, termed “charging operation”.

$$R 1 : {H}_{2} O + 2 {e}^{-} + Q \to {H}_{2} + \frac{1}{2} {O}_{2}$$

The second reaction R2 is advantageously carried out when the fuel cell 2 operates in the discharge regime. The second reaction R2 is implemented in the fuel cell 2 when this operates according to a second operating mode F2, termed “discharge operation”.

$$R 2 : {H}_{2} + \frac{1}{2} {O}_{2} \to {H}_{2} O + 2 {e}^{-} + Q$$

The fuel cell 2 advantageously operates in the first and the second operating mode F1, F2, at a temperature T1 referred to as the “nominal operating temperature”. The nominal operating temperature T1 of the fuel cell 2 is, for example, 850°+/−20%. The operation of the fuel cell at this temperature T1 has a number of advantages. More specifically, it enables the operating voltage to be reduced, the reaction kinetics in the fuel cell to be accelerated and energy losses to be reduced, and makes it possible to use a single type of reversible cell instead of two in a low-temperature operation.

According to an embodiment, the system 1 comprises a heating device 20, called the second heating device 20, that can be controlled by a regulator, in order to heat the fuel cell 2 to the predefined nominal operating temperature T1.

The system 1 further comprises, for the fuel cell 2, a valve for admitting and ejecting hydrogen 21, a valve for ejecting oxygen 22, a valve for admitting oxygen 23 and a valve for admitting and ejecting water 24.

The first storage device 3 and the second storage device 4 are connected to the fuel cell 2 in order to store the hydrogen H₂ produced during the first reaction R1 in the electrolysis regime and to restore it as reactant of the second reaction R2 in order to supply the fuel cell 2 in the discharge regime.

### First Storage Device

The first storage device 3 comprises a first material M1 able to absorb hydrogen H₂ by forming, with hydrogen H₂, a first metal hydride HM1 when the hydrogen H₂ is at a first pressure P0 and a temperature TO, termed ambient temperature TO, and to release the hydrogen H₂ by desorption at a second pressure P1, greater than the first pressure P0.

The term “hydride” shall mean a chemical compound formed from hydrogen H₂ and another more electronegative element. A metal hydride is therefore a chemical compound formed from hydrogen H₂ and a metallic element M. The metal forming the metal hydride is advantageously chosen in order to facilitate the absorption and desorption of hydrogen H₂, to maximise the storage capacity and to select an operating pressure and temperature range. In addition, the metal hydride HM generates heat during the storage of hydrogen H₂ and releases hydrogen H₂ when the metal hydride HM is heated. The quantity of heat generated by the metal hydride HM during the storage of hydrogen H₂ is linked to the enthalpy of each metal hydride HM, denoted ΔH and referred to as the “standard enthalpy of formation of the metal hydride” or “enthalpy of absorption/desorption of the metal hydride” or more simply as the “enthalpy of absorption of the metal hydride”. The value of the enthalpy of absorption of a metal hydride HM is correlated with the slope of the Van′t Hoff straight line of the metal hydride HM in a Van′t Hoff diagram. In other words, the higher the absolute value of the slope of the Van′t Hoff straight line of a metal hydride HM in the Van′t Hoff diagram, the higher the absolute value of the enthalpy of absorption of the metal hydride HM.

The first pressure P0 is, for example, equal to 1 bar.

The second pressure P1 is, for example, equal to 10 bar.

The first material M1 is, for example, chosen from lanthanum, titanium, vanadium, nickel or a combination of these elements, such as, for example, LaNi₅, FeTi or FeTi_{0.85}Mn_{0.05}. Such a first material M1 is able to absorb hydrogen H₂ by forming, with hydrogen H₂, a first metal hydride HM1 for example of the type LaNi₅H₂, FeTiH₂ or FeTi_{0.85}Mn_{0.05}H₂.

According to an embodiment, the system 1 comprises a heating device 31, called first heating device 31, for heating the first metal hydride HM1 of the first storage device 3, so as to take the pressure of hydrogen from the first pressure P0 to the second pressure P1. The heating device 31 is suitable for heating the first storage device 3 to a temperature T3, preferably 60° C.

According to an embodiment, the first storage device 3 comprises an inlet/outlet line 32 and a valve 36. The valve 36 is able:
to connect the inlet/outlet line 32 to a supply of hydrogen H₂ of the first storage device (described below) in order to implement the absorption, or
to connect the inlet/outlet line 32 to a hydrogen H₂ evacuation of the first storage device 3 (described below) in order to implement the desorption, or
to close the inlet/outlet line 32 in order to heat, without desorbing it, the hydrogen H₂ stored in the first storage device 3.

According to an embodiment, the first storage device 3 comprises a plurality of storage cells 35, each comprising a valve 36. The valve 36 of each storage cell 35 is able to be controlled in order to connect the inlet/outlet line 32 to the supply of hydrogen H₂ from the first storage device or to the hydrogen H₂ evacuation of the first storage device 3, independently of the other storage cells 35. Hence, each storage cell 35 is able to be supplied with hydrogen H₂ coming from the fuel cell 2, heated by the heating device 31 and to be discharged of hydrogen H₂ to the second storage device 4. The number of storage cells 35 of the first storage device 3 is determined in order to produce, according to the first operating mode F1, a desired transfer flow of hydrogen H₂ between the first storage device 3 and the second storage device 4.

### Second Storage Device

The second storage device 4 comprises a second material M2, different from the first material M1. The second material M2 is able to absorb hydrogen H₂ by forming, with the hydrogen H₂, a second metal hydride HM2 when the hydrogen H₂ is at the second pressure P1.

The second storage device 4 is thus able to store hydrogen H₂ when this is at a pressure equal to the second pressure P1 of desorption of hydrogen H₂ by the first storage device 3.

The second metal hydride HM2 preferably has an enthalpy of absorption greater in absolute value than an enthalpy of absorption of the first metal hydride HM1. Advantageously, the enthalpy of absorption of the second metal hydride HM2 is at least twice as high (in absolute value) as the enthalpy of absorption of the first metal hydride HM1.

Thus, the second metal hydride HM2 of the second storage device 4 is capable of storing hydrogen H₂ at higher pressure than the first metal hydride HM1 of the first storage device 3 and therefore of storing a larger quantity of hydrogen (with an equivalent mass of material). Moreover, the second metal hydride HM2, of the second storage device 4, is capable of storing hydrogen H₂ by generating a larger quantity of heat than the heat generated during the storage of hydrogen H₂ by the first metal hydride HM1, of the first storage device 3.

The second material M2 is, for example, chosen from magnesium or sodium, or a combination of these elements, such as Mg, NaMg, Mg₂Fe or Mg₂. The second metal hydride HM2 can be chosen from the compounds of the magnesium family, such as MgH₂, NaMgH₂, Mg₂FeH₆, Mg₂NiH₄. Magnesium hydroxide is particularly interesting because it has a very large capacity to absorb hydrogen H₂ and it generates a large quantity of heat during the process of storage by absorption at a pressure equal to the second pressure P1 of desorption of hydrogen H₂ by the first storage device 3.

For example, the enthalpy of absorption of magnesium hydride MgH₂ is −75.2 KJ/mol, whereas the enthalpy of absorption of lanthanum-nickel hydride LaNi₅H₂ is −30.8 KJ/mol (the negative values being due to the reference to the material which releases heat during absorption). Magnesium hydride therefore releases a larger quantity of heat during absorption of hydrogen H₂ than lanthanum-nickel hydride.

The table below summarises the properties of certain hydrides which can be used:

| | Quantity of | ΔH (standard | Heat | Equilibrium |
|---|---|---|---|---|
| | hydrogen | enthalpy of | storage | temperature |
| | stored | formation | density | (° C.) at 1 |
| | (% mass) | kJ/mol) | (kWh/kg) | bar pressure |
| LaNi₅H₂ | 1.38 | 30.8 | 0.02 | 25 |
| (first | | | | |
| hydride) | | | | |
| MgH₂ | 7.7 | 75 | 0.78 | 280 |
| (second | | | | |
| hydride) | | | | |

According to an embodiment, the system 1 comprises a first heat exchanger 41 which can heat the second metal hydride HM2 of the second storage device 4 and, by this, promotes the desorption of hydrogen H₂ stored in the second storage device 4 when the fuel cell 2 operates in the second operating mode F2, and heating the water supplying the fuel cell 2 when the fuel cell 2 operates in the first operating mode F1. Advantageously, the first heat exchanger 41 is able to cause desorption of the hydrogen H₂ of the second storage device 4 at a temperature T4 of 300° C., +/−25%. In addition, the first heat exchanger 41 is able to heat the water supplying the fuel cell 2, to temperature T4.

According to an embodiment, the second storage device 4 comprises a cell 42, an internal line 43 and advantageously a valve 44. The internal line 43 is able to receive hydrogen H₂ desorbed by the first storage device 3. The valve 44 is suitable for connecting the cell 42 to the internal line 43. Optionally, the second storage device 4 comprises more than one cell 42, and one valve 44 per cell 42, so as to be able to independently connect each cell 42 to the internal line 43.

The system 1 further comprises a network of lines. The network of lines comprises: a line for transporting hydrogen 6a, 6b, a line for transporting water 7a, 7b, and a line for transporting oxygen 9, as well as a second heat exchanger 81, a connection valve 5, a condenser 61 and a water tank 71.

The line for transporting hydrogen 6a, 6b, transports hydrogen H₂ between the fuel cell 2 and/or the first storage device 3 and/or the second storage device 4. The line for transporting hydrogen 6a, 6b communicates with the valve for admitting and ejecting hydrogen 21 of the fuel cell 2 and with the first and the second storage device 3, 4. More precisely, the line for transporting hydrogen 6a, 6b, comprises a charging channel 6a and a discharge channel 6b.

The charging channel 6a extends from the valve for admitting and ejecting hydrogen 21 to the valve 36 of the first storage device 3. The charging channel 6a passes into the second heat exchanger 81, then into the condenser 61. The second heat exchanger 81 enables a heat exchange between hydrogen H₂ produced by the fuel cell 2 and the water supplying the fuel cell 2. The heat exchange between hydrogen H₂ produced by the fuel cell 2 and the water supplying the fuel cell 2 enables the water supplying the fuel cell 2 to receive heat and to attain temperature T2. The condenser 61 separates, by condensation, the residual water from hydrogen H₂ circulating in the charging channel 6a. Indeed, hydrogen generated by the fuel cell 2 is mixed with the residual water which has not been consumed by the fuel cell 2 when the fuel cell 2 operates in the first operating mode F1. The charging channel 6a, is connected to the first storage device 3 and, more precisely, to valve 36 of the first storage device 3, in order to supply the first storage device 3 with hydrogen H₂ produced by the fuel cell 2. Finally, the charging channel 6a connects the valve 36 of the first storage device 3 to the connection valve 5 of the second storage device 4.

The discharge channel 6b extends from the connection valve 5 to the valve for admitting and ejecting hydrogen 21. The discharge channel 6b passes through the second heat exchanger 81. Optionally, the discharge channel 6b also connects the inlet/outlet line 32 of the first storage device 3 to the valve for admitting and ejecting hydrogen 21.

The line for transporting water 7a, 7b communicates with the valve for admitting and ejecting water 24 of the fuel cell 2 and with the first and the second storage device 3, 4. More precisely, the line for transporting water 7a, 7b, comprises a water charging channel 7a and a water discharge channel 7b.

The water charging channel 7a extends from the condenser 61 to the water tank 71 on the one hand, and to the heating device 31 of the first storage device 3 on the other hand. Then, the water charging channel 7a connects the water tank 71 to the valve for admitting and ejecting water 24 on passing through the first heat exchanger 41 then through the second exchanger 81.

The water discharge channel 7b extends from the valve for admitting and ejecting water 24 to the first heat exchanger 41. The water discharge channel 7b passes through the second heat exchanger 81. Then, the water discharge channel 7b communicates with the water tank 71, optionally passing into the additional heat exchanger 83 in order to supply an external hot water network. Moreover, the water discharge network 7b connects the water tank 71 to the heating device 31 of the first storage device 3.

The line for transporting oxygen 9 communicates with the valve for ejecting oxygen 22, the valve for admitting oxygen 23, and an external oxygen source (not shown). The external oxygen source can be the ambient air. More specifically, the external source can supply the system 1 with pure oxygen or with air comprising oxygen, but for which only the oxygen participates in the second reaction R2. More precisely, the line for transporting oxygen 9 extends from the external oxygen source and to the valve for admitting oxygen 23 passing through an air/air heat exchanger 82. Then, the line for transporting oxygen 9 connects the valve for ejecting oxygen 22 with the atmosphere by passing through the air/air heat exchanger 82.

According to an embodiment, the system 1 comprises a regulator 200 able to control:
the second heating device 20 for keeping the fuel cell 2 at the nominal operating temperature T1 of the fuel cell 2,
the first heating device 31, for heating the first storage device 3 in such a way as to take the pressure of hydrogen H₂ from the first pressure P0 to the second pressure P1 and/or to cause the desorption of hydrogen H₂ by the first storage device 3,
the first exchanger 41, so as to alternatively heat the second metal hydride HM2 of the second storage device 4 and, by this, to cause the desorption of hydrogen H₂ stored in the second storage device 4, when the fuel cell 2 operates in the second operating mode F2, or to heat the water supplying the fuel cell 2 when the fuel cell 2 operates in the first operating mode F1,
each valve 36 of cell 35 for connecting the inlet/outlet line 32 to the charging channel 6a or to the discharge channel 6b,
each valve 44 of cell 42 for connecting to the internal line 43, and
the connection valve 5 for connecting the internal line 43 of the second storage device 4 to the charging channel 6a or to the charging channel.

### Charging Operating Mode

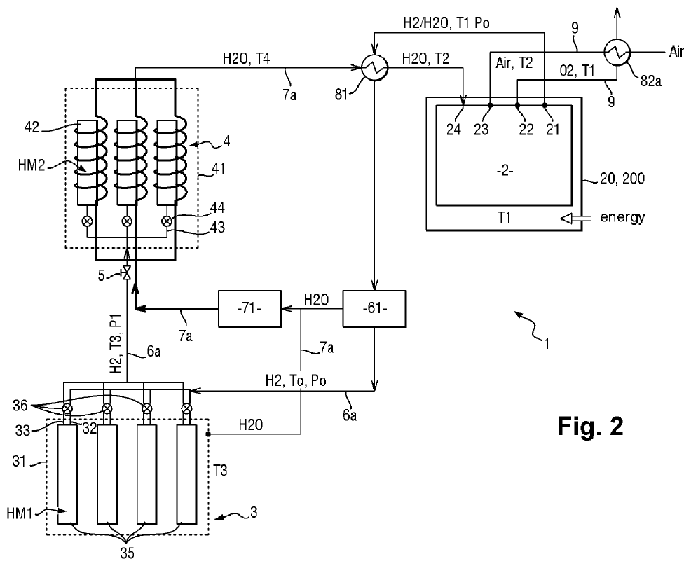

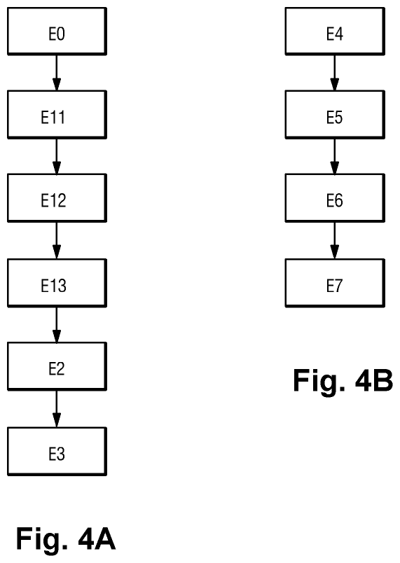

FIG. 2 schematically represents the configuration in which the system 1 is found when the fuel cell 2 operates according to the first operating mode F1. Further, FIG. 4A illustrates the main steps of the implementation of the method using this system 1, in the first operating mode F1.

As described previously, the first operating mode F1 is the so-called “charging” operating mode, implementing the first reaction R1. The first reaction R1 is an electrolysis reaction which produces hydrogen H₂ and oxygen O₂, by providing water and energy in the form of electrical energy and heat. In order to implement the first reaction R1, it is therefore necessary to supply the fuel cell 2 with electrical energy from an energy source.

During the electrolysis step (step E0), the fuel cell 2 produces a mixture comprising gaseous hydrogen H₂ and steam. The steam consists of residual water which has not been consumed by the first reaction R1. The hydrogen/water mixture produced by the fuel cell 2 is at the first pressure P0 of 1 bar and at the nominal operating temperature T1 when the hydrogen/water mixture passes through the valve for admitting and ejecting hydrogen 21 of the fuel cell 2.

A portion of the heat of the hydrogen/water mixture is transmitted by the second heat exchanger 81, to the water circulating in the water charging channel 7a of the fuel cell 2, which supplies water to the fuel cell 2, so as to take the water from temperature T4 to a temperature T2, greater than temperature T4. More specifically, the fuel cell 2 is advantageously supplied with water at temperature T2. Temperature T2 is preferably 800° C.+/−15%. The other portion of the heat of the hydrogen/water mixture circulating in the charging channel 6a can subsequently be transmitted to the first storage device 3.

The mixture comprising hydrogen H₂ and steam is sent into a condenser 61 in order to separate the hydrogen H₂ from the steam. This is therefore gaseous hydrogen H₂ at the first pressure P0 and temperature T0, coming from the condenser 61 which is transmitted to the first storage device 3.

The first storage device 3 stores hydrogen H₂ at the first pressure P0, during an absorption step (step E11) by the first material of the first storage device 3, by forming the metal hydride HM1. The valve 36 then connects the charging channel 6a to the input line 32 of the first storage device 3 in order to fill the storage device 3 with hydrogen H₂ coming from the fuel cell 2. Once the absorption (step E11) is carried out, the valve 36 is closed, i.e. it no longer connects the inlet/outlet line 32 to the charging channels 6a.

Then, the metal hydride HM1 is heated (step E12) by means of the heating device 31 to temperature T3. The heating of the metal hydride HM1 of the first storage device 3 induces an increase in the pressure of hydrogen H₂ inside the metal hydride HM1 of the first storage device 3. Advantageously, at temperature T3, the metal hydride HM1 is at pressure P1.

Once the hydrogen stored in the form of metal hydride HM1 has reached pressure P1, the valve 36 is ordered to connect the inlet/outlet line 32 of the storage device 3 to the charging channel 6a downstream of the first storage device 3 in order to release hydrogen H₂.

Then, the first storage device 3 releases (step E13) hydrogen H₂ stored in the metal hydride HM1 by desorption. The hydrogen H₂ is released at temperature T3 and pressure P1.

According to an embodiment, the heating device 31 of the first storage device 3 heats (step E12) the metal hydride HM1 by means of the heat coming from of the steam formed from residual water which has not been consumed by the first reaction R1.

According to an embodiment, the first storage device 3 comprises at least three cells 35 and, for example, four cells 35. Each cell 35 is connected to a respective inlet/outlet line 32. In addition, the first storage device 3 comprises a control module (not shown), able to individually control, for each cell 35:
the connection of the inlet/outlet line 32 to the charging channel 6a upstream, and thus the absorption of hydrogen H₂ (step E11);
the individual closure of the valve 36 during the heating of the metal hydride HM1 by the heating device 31 (step E12), and
the connection of its inlet/outlet line 32 to the charging channel 6a downstream, and thus the desorption of hydrogen H₂ (step E13).

Hence, each cell 35 of the first storage device 3 is selectively able to absorb (step E11) and release (step E13) hydrogen H₂ independently of the other cells 35 of the first storage device 3. In this way, the first storage device 3 can release (step E13) hydrogen H₂ at the second pressure P1 and at temperature T3 in order to supply a continuous flow of hydrogen H₂ to the second storage device 4 during the operation of the fuel cell 3 in the first operating mode F1. More specifically, a plurality of cells 35 operating independently from one another makes it possible to control the absorption of one cell 35 after the other, until the first storage device 3 is filled, and the desorption of one cell 35 after the other in order to enable filling of the second storage device 4.

The hydrogen H₂ desorbed (step E13) by the first storage device 3 at pressure P1 and temperature T3 is transmitted by means of the charging channel 6a (downstream) to the second storage device 4 in order to be stored by it. The connection valve 5 connects the second storage device 4 to the charging channel 6a. The second storage device 4 stores (step E2), by absorption, hydrogen H₂ coming from the first storage device 3 at pressure P1. The second storage device 4 stores hydrogen H₂ released by the first storage device 3 at the same speed as the first storage device 3 releases (step E13) hydrogen H₂ that it has previously stored.

The absorption of hydrogen H₂ at pressure P1 by the second storage device 4 generates heat. At least a part of the heat produced by this absorption (step E2) is transmitted (step E3) to the fuel cell 2. For this purpose, the first heat exchanger 41 of the second storage device 4 transmits the heat, produced by the absorption of hydrogen H₂ by the second storage device 4, to the fuel cell 2 by means of the water present in the water charging channel 7a. The heated water circulating in the water charging channel 7a downstream of the second storage device 4 is at temperature T4. The water charging channel 7a then passes through the second heat exchanger 81 in order to receive heat from hydrogen and thus attain temperature T2. The water charging channel 7a finally supplies the fuel cell 2 with water at the supply temperature T2, +/−20%. Such a temperature makes it possible to attain an optimum overall energy yield in the fuel cell 2. The quantity of electrical energy required by the first reaction R1 is then lower and at least a part of the heat necessary for the first reaction R1 can effectively be provided by the water circulating in the water charging channel 7a.

Hence, the heat generated by the absorption of hydrogen H₂ at pressure P1 by the second storage device 4 is sufficiently large to heat the water circulating in the water charging channel 7a such that the temperature of the water circulating in the water charging channel 7a is, downstream of the second storage device 4, at the temperature of second device T4 and supplies the fuel cell 2 at the supply temperature T2, +/−20%. In other words, the absorption of hydrogen H₂ at pressure P1 by the second storage device 4 generates the quantity of heat necessary to vaporise the water supplying the fuel cell 2 when the fuel cell 2 operates in the first operating mode F1.

According to an embodiment, the residual water coming from the separation of hydrogen H₂ and steam by the condenser 61 is stored in a tank 71 and then supplies the charging water channel 7a.

According to an embodiment, oxygen O₂ produced by the first reaction R1 is at the nominal operating temperature T1. A part of the heat of this oxygen O₂ is transmitted, using the air/air heat exchanger 82, to oxygen supplying the fuel cell 2, circulating in the oxygen supply circuit, upstream of the fuel cell 2. In this way, the oxygen O₂ which supplies the fuel cell 2 is at temperature T2, +/−20% at the valve for oxygen ejection 22 from the fuel cell 2.

### Discharging Operating Mode

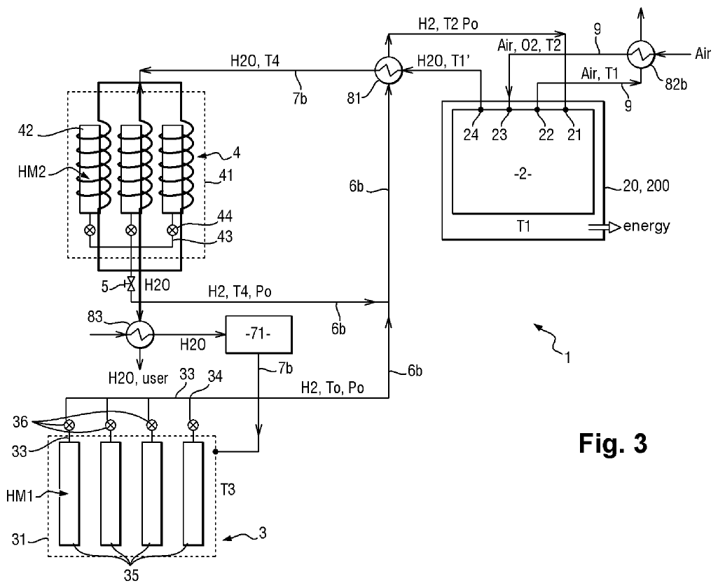

FIG. 3 schematically represents the configuration in which the previously described system 1 is found when the fuel cell 2 operates in a second operating mode F2. Further, FIG. 4B illustrates the main steps of the implementation of the method using this system 1 in the second operating mode F2.

As previously described, the second operating mode F2 is the so-called “discharge” operating mode. In discharge operation, the fuel cell 2 implements the second reaction R2. The second reaction R2 is a mode of the fuel cell 2 which produces electricity and advantageously heat, while consuming hydrogen H₂ and oxygen.

The second reaction R2 being an exothermal reaction, it produces heat and water which transports this heat. The water produced by the second reaction R2 is at the valve for admitting and ejecting water 24 from the fuel cell 2 at the nominal operating temperature T1. The water passes through the water discharge channel 7b and supplies (step E4) heat to the first heat exchanger 41 of the second storage device 4.

Moreover, the water of the water discharge channel 7b transmits heat to the hydrogen H₂ of the discharge channel 6b which supplies the fuel cell 2 using the second heat exchanger 81, so that the hydrogen H₂ is at temperature T2, +/−20% at the valve for admitting and ejecting hydrogen 21 from the fuel cell 2.

According to an embodiment, the water which passes through the water discharge channel 7b also supplies (step E5) the heating device 31 of the first storage device 3. Advantageously, the water discharge channel 7b supplies the first heat exchanger 41 then the heating device 31. The first heat exchanger 41 and the heating device 31 respectively heat the first and second metal hydrides HM2 and HM1, respectively to temperature T4 and temperature T3, which enables release by desorption (step E6) of the hydrogen H₂ stored in each of the second storage device 4 and the first storage device 3. The hydrogen H₂ is preferably desorbed from each of the first storage device 3 and the second storage device 4 at the first pressure P0. The use of a part of the heat produced by the second reaction R2, transported by the water produced by the fuel cell 2, in order to release by desorption (step E6) the hydrogen H₂ stored in the second storage device 4 and the first storage device 3, contributes to improving the overall energy yield of the system 1 to attain a value of order 50%.

The hydrogen H₂ desorbed from the second storage device 4, and optionally from the first storage device 3, supplies (step E7) the fuel cell 2 using the discharge channel 6b. The hydrogen H₂ at the valve for admitting and ejecting hydrogen 21 of the fuel cell 2 is at temperature T2, +/−20%, and at the first pressure P0.

According to an embodiment, the water transporting the heat produced by the second reaction R2 in the water discharge channel 7b supplies an external facility (not shown), for example for domestic heating, by means of an additional heat exchanger 83.

According to an embodiment, the water of the water discharge channel 7b is stored in a tank 71 after having supplied (step E4) the first heat exchanger 41 with heat. Optionally, the tank 71 stores the water of the water discharge channel 7b after the water has passed through the second storage device 4 and the external facility, then supplies (step E5) the heating device 31. In this way, the heat transported by the water of the water discharge channel 7b is preferably transmitted to the second storage device 4 and to the external facility. More specifically the first storage device 3 only requires to be heated to a temperature T3, less than temperature T4, in order to release (step E6) hydrogen H₂.

According to an embodiment, and in the same way as in the first operating mode F1, a portion of oxygen O₂ has been consumed by the second reaction R2, but oxygen O₂ which has not been consumed by the second reaction R2 is at the nominal operating temperature T1 at the valve for ejecting oxygen 22. A part of the heat from the oxygen O₂ which has not been consumed is transmitted, using the air/air heat exchanger 82b, to the line for transporting oxygen 9 (not visible in FIG. 3) transporting oxygen to the fuel cell 2. In this way, oxygen O₂ which supplies the fuel cell 2 is at temperature T2, +/−20% at the valve for admitting oxygen 23 of the fuel cell 2.

The temperature and pressure values are not limiting; they are an example of values and other values can be used.

The invention advantageously combines the technology of fuel cells and metal hydrides.

The system 1 operates reversibly according to the needs, for example, of the electricity distribution network.

The use of the first storage device 3 enables the compression of the hydrogen produced by the fuel cell 2 by using the heat of the endothermic reaction (first reaction R1) and thus the absorption of hydrogen by the second storage device 4. The first storage device 3 is termed a low-temperature storage device because the storage temperature TO of the first storage device 3 is less than temperature T3 which is the storage temperature of the second storage device 4.

Further, the use of a low-temperature storage device 3 to solve the operating problems in the first operating mode F1 additionally increases the hydrogen storage capacities of the system 1. More specifically, when the fuel cell 2 operates in the second operating mode F2, the low-temperature storage device 3 also desorbs the hydrogen which it stores in order to supply the fuel cell 2.

1. A system comprising:
a fuel cell configured to operate selectively in a first operating mode and in a second operating mode, such that:
in the first operating mode, the fuel cell consumes electrical energy in order to produce hydrogen and oxygen, and
in the second operating mode, the fuel cell produces electrical energy while consuming hydrogen and oxygen;
a first storage device for storing hydrogen produced by the fuel cell when the fuel cell is in the first operating mode, the first storage device comprising a first material able configured to absorb hydrogen (by forming, with the hydrogen, a first metal hydride when the hydrogen is at a first pressure, and releasing hydrogen by desorption when the hydrogen is at a second pressure, greater than the first pressure, the first metal hydride having a first enthalpy of absorption;
a second storage device configured to store hydrogen coming from the first storage device, the second storage device comprising a second material, different from the first material, the second material being configured to absorb hydrogen by forming, with the hydrogen, a second metal hydride when the hydrogen is at the second pressure, the second metal hydride having a second enthalpy of absorption, greater, in absolute value, than the first enthalpy of absorption of the first metal hydride.

2. The system according to claim 1, further comprising a first heating device configured to heating the first metal hydride, and to take a pressure of hydrogen stored in the first storage device from the first pressure to the second pressure.

3. The system according to claim 2, wherein the first heating device is configured to be supplied with heat by a residual water which has not been consumed by the fuel cell when the fuel cell operates in the first operating mode.

4. The system according to claim 1, wherein the second material is configured to produce, during a storage by absorption of hydrogen in the second material, a quantity of heat necessary to vaporise water supplying the fuel cell when the fuel cell operates in the first operating mode.

5. The system according to claim 1, further comprising a first heat exchanger configured to transfer the heat produced during the storage by absorption of hydrogen in the second material, to water supplying the fuel cell when the fuel cell operates in the first operating mode.

6. The system according to claim 5, wherein the first heat exchanger is configured to transfer heat from water produced by the fuel cell to the second metal hydride causing desorption of the hydrogen stored in the second storage device, in order to supply the fuel cell with the hydrogen when the fuel cell operates in the second operating mode.

7. The system according to claim 1, further comprising a second heat exchanger configured to transfer heat from the hydrogen produced by the fuel cell to water supplying the fuel cell, to supply the fuel cell with steam when the fuel cell operates in the first operating mode.

8. The system according to claim 7, wherein the second heat exchanger is configured to transfer heat from water produced by the fuel cell to hydrogen coming from the first storage device and/or the second storage device, and to supply the fuel cell with heated hydrogen when the fuel cell operates in the second operating mode.

9. The system according to claim 1, further comprising a condenser for separating hydrogen produced by the fuel cell and the residual water which has not been consumed by the fuel cell when the fuel cell operates in the first operating mode.

10. The system according to claim 1, wherein the first storage device comprises:
a plurality of storage cells and an inlet/outlet line, each storage cell being configured to be supplied with hydrogen coming from the fuel cell and to be discharged of hydrogen to the second storage device via the inlet/outlet line; and
a valve configured to be controlled in order to selectively connect the inlet/outlet line of each storage cell to a line for transporting hydrogen, the line being configured to transport hydrogen between the fuel cell and/or the first storage device and/or the second storage device, independently of the other storage cells.

11. The system according to claim 1, further comprising a connection valve configured to selectively connect the second storage device;
to the first storage device, in order to supply the second storage device with hydrogen coming from the first storage device when the fuel cell operates in the first operating mode; or
to the fuel cell in order to supply the fuel cell with hydrogen coming from the second storage device when the fuel cell operates in the second operating mode.

12. The system according to claim 1, further comprising a second heating device and a regulator configured to control the second heating device in order to keep the fuel cell at a predefined nominal operating temperature between 650° and 850°.

13. The system according to claim 1, wherein the first material of the first storage device comprises a compound chosen from lanthanum, titanium, vanadium, nickel or a combination of lanthanum, titanium, vanadium, nickel.

14. The system according to claim 1, wherein the second material of the second storage device comprises magnesium.

15. A method for operating a system according to claim 1, wherein the fuel cell operates in the first operating mode, the method comprising the steps of:
storing, by absorption, hydrogen produced by the fuel cell at the first pressure in the first storage device;
heating the first metal hydride so as to take the hydrogen stored in the first storage device from the first pressure to the second pressure;
releasing, by desorption, the hydrogen stored in the first storage device; and
storing, by absorption, the hydrogen released from the first storage device in the second storage device at the second pressure, the second storage device storing the hydrogen released at the same speed as the first storage device releases the stored hydrogen.

16. The method for operating a system according to claim 1, wherein the fuel cell operates in the second operating mode, the method comprising:
heating the second metal hydride to cause a desorption of hydrogen stored in the second storage device, and
supplying the fuel cell with the hydrogen desorbed from the second storage device.

17. The method according to claim 16, further comprising:
heating the first metal hydride so as to cause a desorption of hydrogen stored in the first storage device, and
supplying the fuel cell with the hydrogen desorbed from the first storage device.
